(19) United States
(12) Patent Application Publication
(10) Pub. No.: US 2017/0167187 A1
(43) Pub. Date: Jun. 15, 2017

(54) COVER FOR CLEANOUT ACCESS

(71) Applicant: RANDALL J. SIEGEL, WILMINGTON, NC (US)

(72) Inventor: RANDALL J. SIEGEL, WILMINGTON, NC (US)

(21) Appl. No.: 15/370,388

(22) Filed: Dec. 6, 2016

Related U.S. Application Data
(60) Provisional application No. 62/265,548, filed on Dec. 10, 2015.

(51) Int. Cl. E06B 5/00; F16L 55/00

(52) U.S. Cl. CPC E06B 5/00; F16L 55/00; F16L 45/00

(57) ABSTRACT

A cleanout cover including a mounting ring that is secured to a surface surrounding an opening in a wall or floor through which the cleanout is accessed. Said mounting ring contains means for engaging with a separate dome-shaped cover with complementary engaging locking tabs and slots. The mounting ring is first attached to the adjacent surface. Next, the cover is locked into place over the mounting ring thus forming a fully functioning cleanout cover that does not directly engage with the cleanout plug. When the user desires to access the plumbing system, they simply twist the dome cover in the opposite direction and unlock the tabs located on the cover from the complementary slots located on the mounting ring. The dome cover is thereby removed and the cleanout plug is accessible through the wall.

### CROSS-REFERENCE TO RELATED APPLICATIONS

This application claims the benefit of priority to U.S. Provisional Application No. 62/265,548 filed on Dec. 10, 2015. The content of U.S. Provisional Application No. 62/265,548 filed on Dec. 10, 2015 is incorporated by reference in its entirety.

### BACKGROUND OF THE INVENTION

(a) Field of the Invention

The present invention relates to a fitting for an access point in a plumbing system. More particularly, the present invention concerns cleanout covers designed to cover access points in a residential or commercial plumbing systems.

(b) Background Art

Generally local plumbing codes require there be an entry through which a plumbing system can be accessed to allow for the maintenance and cleaning of the plumbing system. These required entry points are generally known as “cleanouts” in the plumbing industry. Cleanouts generally consist of the open end of a pipe closed via a plug screwed over the threaded ends of the open pipe. The cap is generally shaped to accept a wrench. Cleanouts are generally accessible through openings in the walls or the floors of a structure. Because the plugs covering the cleanouts and the openings in the walls and floors are considered unsightly, cleanout covers are used to cover the openings through which cleanouts are accessed. Cleanouts are typically located inside the wall such that the cleanout covers are flush with the outer edge of the wall or other surrounding surface.

Traditional cleanout covers are typically secured to the cleanout plug itself. Such securing is accomplished using a screw or other fastening means. In general, cleanout covers will engage with the plug that closes the cleanout. Oftentimes, doing so requires the use of a fastener that penetrates the plumbing system itself exposing the fastener to the inside of the plumbing system. Moisture from the plumbing system will tend to corrode metal screws and similar fasteners over time. As a result, there have been attempts to develop cleanout covers that do not require a screw or other fastening means that penetrate the plumbing system.

For example, U.S. Pat. No. 5,642,973 (the “973 patent”) discloses a cleanout cover featuring a hollow mounting tube centered on the interior surface of the cover, and a series of spaced and resilient flanges on the interior of the hollow mounting tube that deform, but by their resiliency “grip” a cleanout plug. Access to the cleanout can be accomplished by turning the cleanout cover allowing the resilient flanges to grip the plug and unscrew it from the cleanout.

Oftentimes, the type of cleanout cover that can be used depends upon the particular fitting or plug used to close the cleanout. For example, some cleanout covers involve a structure on the cleanout cover physically engaging with a tool cutout on the cleanout plug itself. In more detail, U.S. Pat. No. 4,701,089 (the “089 patent”) discloses a cover for plumbing closure plugs and the like that generally includes a cylindrical plate with axially positioned and extending latching fingers that operate to engage a tool cross slot in the plumbing closure plug, thereby holding the cover in place while the plug is unscrewed. This particular solution is dependent on the cleanout plug having the tool cutout to be engaged with and, as a result, it will not function with every cleanout plug.

Similarly, U.S. Pat. No. 4,360,041 (the “041 patent”) discloses a cleanout cover that is fitted with a screw that is configured to attach the cleanout cover to the cleanout plug without penetrating the plumbing system. Again, this solution depends upon the type of cleanout plug that is in place as this system will not work with every plug, only those that are configured to accept the screw.

Likewise, U.S. Pat. No. 6,076,559 (the “559 patent”) discloses a disposable protective cover for protecting a plumbing fixture during floor construction, the cover being a cylindrical casing having a closed end, an open end, and a plurality of locking tabs around its inner circumference, said locking tabs being sufficiently spaced from the closed end of the casing so as to allow the rim of a plumbing fixture to be releasably secured within the casing between the locking tabs and the closed end. While not exactly a cleanout cover, the 559 patent does disclose a plumbing fixture cover that may be installed without the necessity of penetrating the plumbing system with screws or the like.

All of the above solutions require the cleanout cover to be physically attached to the pipe containing the cleanout or the plug covering the opening of the cleanout. As a result, there remains in the field a need for a simpler device that is easier to install without regard to the type of cleanout plug in place and that still does not penetrate the plumbing system.

### BRIEF SUMMARY OF THE INVENTION

The present invention is a cover for plumbing fixtures. More specifically, the presently disclosed device is a cover for a cleanout access that does not require penetrating the plumbing system during installation or use. Even more specifically, the presently disclosed device is a cleanout cover that does not directly engage the cleanout plug closing a cleanout access.

The cover includes a mounting ring that is secured to the surface surrounding the opening in the wall or floor through which the cleanout is accessed. In some preferred embodiments, the mounting ring is an escutcheon ring. In addition, in some preferred embodiments, the mounting ring is attached directly to the surface surrounding the cleanout access point, generally a wall or a portion of flooring, via attachment means featured on a surface of the mounting ring. Said mounting ring contains means for engaging with a separate cover with complementary tabs. In the preferred embodiment, the means whereby the separate cover engages with the escutcheon ring consists of locking tabs. In more detail, the locking tabs consist of one or more slots shaped to receive one or more tabs located on a separate surface. The tabs are located on one of either the mounting ring or the cover with the corresponding complementary slot located on the either the mounting ring or the cover, whichever one does not feature the slot(s). In preferred embodiments, there are three slots and three tabs, but any number of slots and complementary tabs can be used to releasably secure the cover to the mounting ring. In addition, any number of other means to releasably secure the cover to the mounting ring can be used in place of locking tabs, including but not limited to traditional fasteners such as screws, nuts and bolts as well as fasteners that are easier to detach and reattach such as hook and loop fasteners, aka Velcro. Alternately, the means by which the cover can be attached to the mounting ring is a tongue-and-groove guide.

Furthermore, the mounting ring is first attached to the wall over the opening located adjacent to the cleanout access. Means for attaching the mounting ring to the adjacent surface can consist of any number of conventional attachment means including double-sided tape, glue, screws, nails, nuts and bolts, etc. Next, the cover is locked into place over the escutcheon ring thus forming a fully functioning cleanout cover that does not directly engage with the cleanout plug.

In the preferred embodiments, the escutcheon ring is made of a durable and aesthetically pleasing metal such as chrome. Moreover, a skilled artisan will realize any number of attachment means already known in the prior art can be used to securely attach the cover to the escutcheon ring. Still further, the cover can be virtually any shape and in the embodiments shown in FIGS. 1-3, the cover is dome-shaped.

### BRIEF DESCRIPTION OF THE SEVERAL VIEWS OF THE DRAWINGS

FIG. 1 is a perspective view of the disclosed cleanout cover attached to a wall;

FIG. 2 is an additional perspective view of the cover and escutcheon ring; and

FIG. 3 is an additional perspective view of the cover.

### DETAILED DESCRIPTION OF THE INVENTION

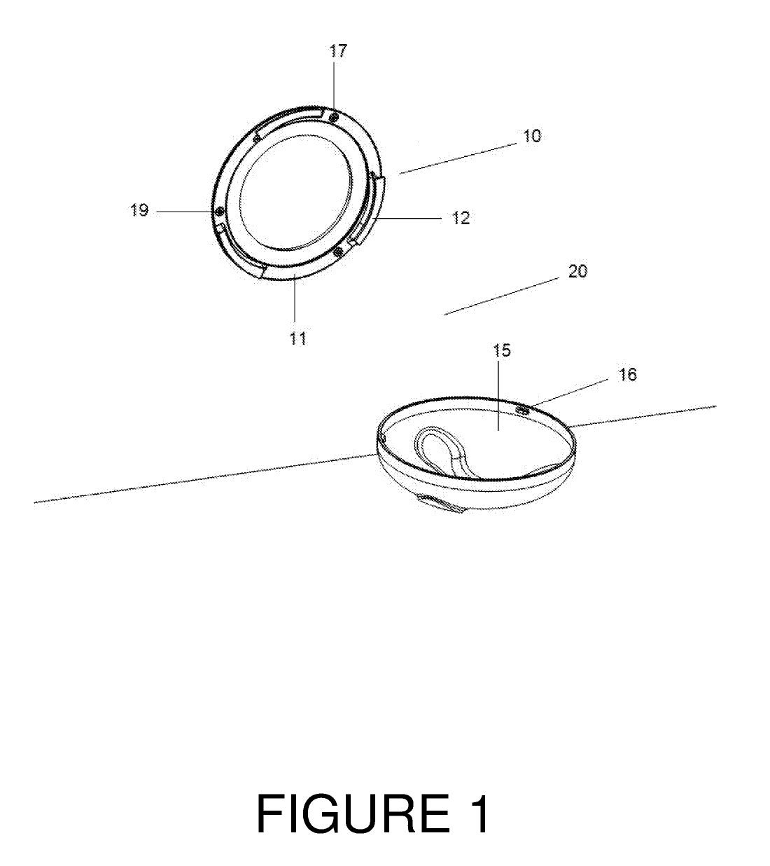

Referring now to the invention in more detail, in FIG. 1 there is shown the disclosed cleanout cover attached to a surface, i.e. a wall 20, with the mounting or escutcheon ring in place and the cover removed. A preferred embodiment of the cleanout cover, generally 10, consists of a mounting ring 11 with fastening means 12 and a separate cover 15. As mentioned above, in some preferred embodiments, the mounting ring 11 is an escutcheon ring. Fastening means 12 in this embodiment are slots located along a surface of the mounting ring 11 that remains exposed after the mounting ring 11 is attached to a surface such as a wall. In a preferred embodiment, there are at least three such slots 12 located along the surface of the mounting ring 11. While not shown in FIG. 1, the mounting ring 11 would, in practice, be placed over an opening (not shown) in the surface or wall 20 that would contain the cleanout access.

Still referring to FIG. 1, the mounting ring 11 can be mounted to the wall 20 via a variety of known fastening means including, but not limited to glues and adhesives, screws and other rigid fasteners, double-sided tape, etc. In a preferred embodiment, the mounting ring 11 includes holes 17 through which screws, nails or other fasteners can be inserted to affix the mounting ring 11 to the surface 20. The means used to mount the mounting ring 11 to another surface 20 will vary depending upon the type of surface. A skilled artisan will appreciate that not all cutouts are located within walls consisting largely of drywall, but they can be located inside cement floors and other surfaces as well. As a result, the device can be configured to utilize any form of attachment means available depending on the surface to which the mounting ring 11 needs to be attached.

Still referring to FIG. 1, there is illustrated a preferred embodiment of the presently disclosed cleanout cover, generally 10, consisting of an mounting ring 11 and a separate cover 15 in which the means to allow the cover 15 to attach to the mounting ring 11 consist of slots 12 located along the surface of the mounting ring 11. These slots 12 allow the cover 15 to engage with the escutcheon ring 11 thus hiding the unsightly opening in the wall 20 and the enclosed cutout (not shown). As above, the cover 15 can be attached to the escutcheon ring 11 using any known fastening means to releasably attach the cover to the ring. Note, since the cover is meant to be removed by a user, the fastening means used to affix the cover 15 to the escutcheon ring 11 must allow for releasable attachment. In a preferred embodiment, the slots 12 are shaped to engage complementary tabs 16 on inner circumference or inner annular surface of the dome cover 15.

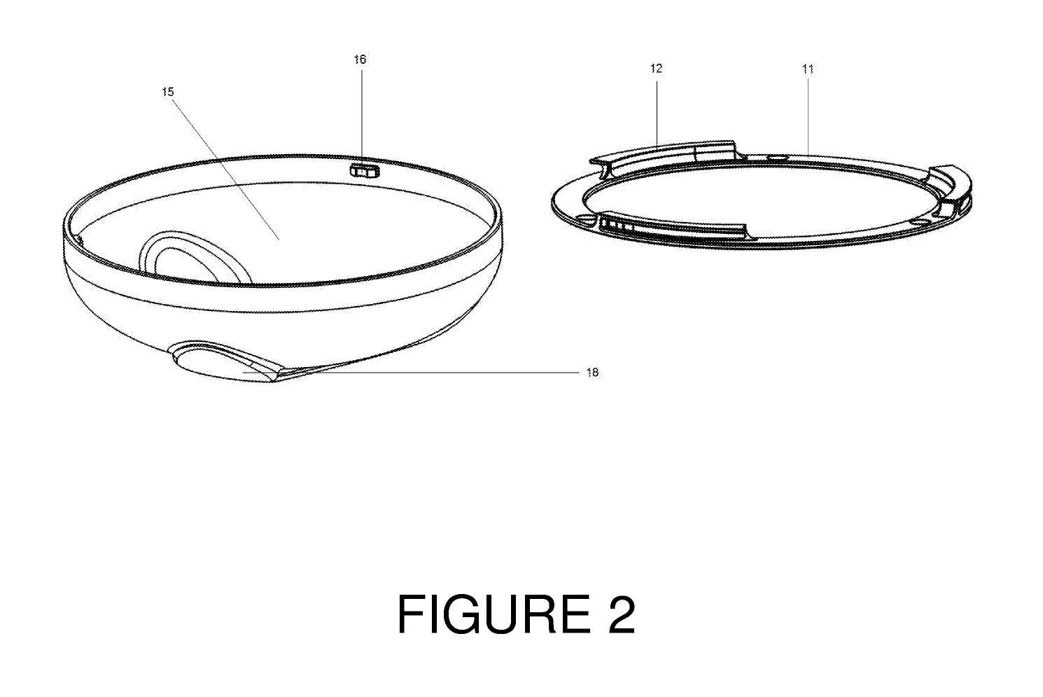

Referring now to the invention in more detail in FIG. 2, there is illustrated the embodiment including a dome-shaped cover 15 and the mounting ring 11. The bottom or underside of the cover 15 features tabs 16 that are complementary in shape and size to the slots 12 located on the mounting ring 11. In a preferred embodiment, the outer surface of the cover includes at least one protrusion 18 that can be grasped by a user wishing to turn the cover 15 and remove it from the mounting ring 11. In yet another preferred embodiment, the protrusion 18 extends in three different directions across the surface of the cover 15.

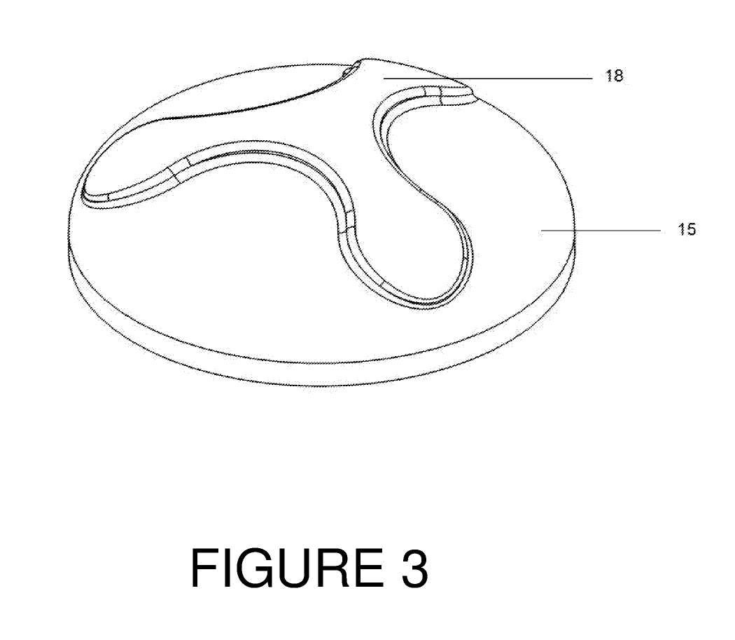

Referring now to a preferred embodiment in more detail, in FIG. 3 there is shown the cover 15 only. As discussed above, the preferred embodiment is dome-shaped and has at least one protrusion 18 on its outer surface making it easier for a user to grasp and turn the cover 15. In yet another preferred embodiment, the protrusion 18 takes the shape of a three-pronged structure.

In practice, the mounting ring 11 is secured to the wall or other adjacent surface 20 that encloses the space in which the cleanout is located. Usually this is a wall made of drywall or a floor with an opening in it to allow access to the plumbing system through the cleanout. The mounting ring 11 is secured in place using conventional fasteners such as screws 17 (see FIG. 1). Once the mounting ring 11 is firmly attached to the adjacent wall or surface 20, the cover 15 is placed over the mounting ring 11 and turned to engage the slots 12 on the mounting ring 11 with the tabs 16 on the cover 15. When the user desires to access the plumbing system, they simply twist the cover 15 in the opposite direction and unlock the tabs 16 from the slots 12. The cover 15 is thereby removed and the cleanout plug is accessible through the wall 20. A skilled artisan should notice that the above configuration can be modified without sacrificing the function of the device. More specifically, the slots 12 could be located on the cover 15 and the tabs 16 could be located on the mounting ring 11.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A device for covering a cleanout access located adjacent to a surface comprising:
a mounting ring;
means to attach the mounting ring to the surface;
a cover; and
means to releasably attach the cover to the mounting ring.

2. The device of claim 1 further wherein the means to releasably attach the cover to the mounting ring consists of:
at least one slot located on a surface of the mounting ring or a surface of the cover and
at least one complementary tab shaped to engage with the at least one slot located on the surface of the mounting ring or the surface of the cover that does not feature the slot,
wherein the tab is located on a surface of the cover such that when the slot on the mounting ring is engaged with the tab on the cover, the cover is releasably attached to the mounting ring.

3. The device of claim 1 wherein the mounting ring is an escutcheon ring.

4. The device of claim 2 wherein the mounting ring is an escutcheon ring.

5. The device of claim 1 wherein the means to mount the mounting ring to the surface comprises at least two holes in the mounting ring through which fasteners can pass to fix the escutcheon ring to the surface.

6. The device of claim 2 wherein the means to mount the mounting ring to the surface comprises at least two holes in the mounting ring through which fasteners can pass to fix the mounting ring to the surface.

7. The device of claim 3 wherein the means to mount the escutcheon ring to the surface comprises at least two holes in the escutcheon ring through which fasteners can pass to fix the escutcheon ring to the surface.

8. The device of claim 4 wherein the means to mount the escutcheon ring to the surface comprises at least two holes in the escutcheon ring through which fasteners can pass to fix the escutcheon ring to the surface.

9. A device for covering a cleanout access located adjacent to a surface comprising:
an escutcheon ring featuring at least two slots and means to mount the escutcheon ring to the surface;
a cover featuring at least two complementary tabs shaped to engage with the at least two slots located on the surface of the escutcheon ring;
wherein when the at least two tabs are engaged with the at least two slots, the cover is releasably attached to the escutcheon ring.

10. The device of claim 9 wherein the means to mount the escutcheon ring to the surface comprises at least two holes in the escutcheon ring through which fasteners can pass to fix the escutcheon ring to the surface.
